(19) United States
(12) Patent Application Publication
(10) Pub. No.: US 2019/0009313 A1
(43) Pub. Date: Jan. 10, 2019

(54) ROBOTIC WATERLESS CLEANING AND INSPECTION SYSTEM WITH AN ASSISTIVE ROBOTIC DOCKING TRAIN SYSTEM AND METHOD

(71) Applicant: Geetanjali Umesh CHOORI, Maharashtra (IN)

(72) Inventor: Geetanjali Umesh CHOORI, Maharashtra (IN)

(21) Appl. No.: 15/918,059

(22) Filed: Mar. 12, 2018

(30) Foreign Application Priority Data
Jul. 8, 2017 (IN) 201721024094

(51) Int. Cl. B08B 17/02; B08B 1/00; H02S 40/10

(52) U.S. Cl. CPC B08B 17/02; B08B 1/002; H02J 7/355; H02S 40/10; B08B 1/005

(57) ABSTRACT

The present disclosure provides robotic portable waterless cleaning/duster system and method that removes dust and other foreign matter accumulated on solar modules across multiple rows. The system includes main frame and trolley, wherein the main frame can move in lateral direction and the trolley can move in longitudinal direction. The main frame is installed with a plurality of wheels that can move laterally on surface of the solar module system. The trolley can include one or more dusters/brushes/wipers that can roll on horizontal axis to allow longitudinal movement of the trolley. The portable waterless robotic cleaning system can be moved manually or by using robotic docking train system or park on docking station. The robotic cleaning system can include vertical brushes or inclined brushes that can be lifted to cross obstacles, and can have inspection instruments mounted on top.

### TECHNICAL FIELD

The present disclosure relates to a robot system for cleaning and inspection of a solar panel (also interchangeably referred to as “photovoltaic solar panels” or “solar modules”), and the like, among services robots or field robots. In particular, the present disclosure relates to a robotic cleaning and inspection system for cleaning and inspection of power generating elements called as solar modules or panels for photovoltaic power generation, and the like.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Now-a-days, natural resources are depleting day by day, and energy requirements of human beings are increasing significantly. Environmental problems such as global warming and depletion of fossil fuels pose a great threat to our future. Most countries have committed to use green (renewable) energy to satisfy a given fraction of their total power consumption, in order to reduce the emission of greenhouse gases. Accordingly, in order to reduce the impact of such environmental problems, use of renewable sources of energy has drawn attention. One such renewable source of energy is solar energy that has drawn attention as an alternative source of energy for various industrial as well as domestic applications. For this reason, the number of solar power plants has increased substantially in the last years, even in Northern European countries not particularly known for being sunny.

A solar cell (or photovoltaic cell) is a semiconductor device that converts solar photovoltaic energy into electrical energy. Solar cells generate charge carriers (electrons and holes) in a light absorbing material, and separate the charge carriers to conductive contacts that transmit electricity. A solar module is a collection or arrangement of solar cells. These modules can be found on the roofs of individual houses with an exposed area of a few square meters, as well as on larger solar modules farms exposing surface areas of dimensions which can vary substantially, from the covering of the roof of a building or a large warehouse with a few rows of solar modules, to entire fields covered with rows and rows of solar modules. In order to optimize the exposure of the solar cells to solar radiations, the solar modules are usually exposed with an angle with respect to the horizontal.

In individual houses, the roof is already sloped and the solar modules are usually mounted parallel to the slope of the roof. In solar power plants, on the other hand, the solar modules usually rest on a substantially horizontal surface and are arranged in a series of usually parallel rows where the modules are arranged side by side, with an angle with respect to the horizontal and separated from the rows in front and on the back by a distance sufficient to prevent the projected shadow of the modules of the front row to be cast onto the modules of the adjacent back row at the peak hours of sun radiation. The tilting angle may vary from about 5 to 10 degrees to up to 45 degrees. Tilting angles of between 30 and 40 degrees are usually considered as optimal, in particular in Northern Europe countries.

In all cases the solar modules must be cleaned in order to not decrease the intensity of the solar radiation reaching the solar cells. Foreign matter carried in the atmosphere can rapidly accumulate and block the incident light falling on the module, preventing a portion of the radiation from being utilized. Frequent cleaning of modules is time-consuming and expensive and cleaning the modules during periods of darkness only slows, but does not prevent, the accumulations. If a few square meters of modules covering the roof of a private house may be cleaned manually, this is not practical when the area of solar modules increases substantially. Automatic cleaning devices for cleaning a series of solar modules aligned in rows have been proposed in the art.

Automated cleaning systems for cleaning solar modules are described in US2010/0043851 and in http://www.solarpanelcleaningsystems.com/, wherein spraying nozzles are disposed at different places in a row or an array of solar modules. However, these cleaning systems do not comprise any means for wiping, brushing, or scrubbing hard adhering dust and dirt off the surface of the modules, and requires/consumes using water/any other liquid as a source for cleaning, and thus cleaning of the modules is therefore not optimal.

Cleaning robots are sometimes used for cleaning solar modules. Their mobility is often rather slow and the passage from one module to another is possible only when the alignment between the two modules is very good. These robots are therefore limited, at least to date, to the cleaning of rather small areas of solar modules. Further, Several solutions for cleaning rows of solar modules comprise a moving cleaning device suitable for moving along the direction of the row and guided by two rails situated on top and at the bottom of the solar modules and running all along the length of the row of solar modules. In some cases, the cleaning device can move along a rail normal to the two guiding rails, to clean the whole surface of the modules, or the cleaning device spans over the whole height of the solar module and moves only in one direction parallel to the guiding rails.

One such device is disclosed in U.S. Pat. No. 8,771,432 B2 that discloses a solar module waterless cleaning system for cleaning solar modules of a plurality of solar module rows, wherein the rows are substantially parallel to each other. The cleaning system includes a waterless cleaning apparatus mounted on a movable frame movable in a direction perpendicular to length direction of the solar module rows, a support frame that supports movement of the waterless cleaning apparatus in width direction and length direction of the solar module rows. The cleaning system further includes a controller coupled to the cleaning apparatus and to the support frame to move the cleaning apparatus in the length direction and the width direction of the solar module row being cleaned, and a drive mechanism for driving the movable frame to a position in alignment with a next solar module row. The cleaning system employs a pair of rails connected to upper edge and lower edge of the solar module row that increases number of components and weight of the system, and thus, increases installation cost of the system. Further, width of the secondary frame is less than width of the movable frame, which confines cleaning area of the solar module row that can be cleaned in one pass and thus, reduces the effectiveness of the cleaning system. Moreover, the cleaning system cannot be used with a solar module that includes a plurality of solar module rows that are misaligned to each other or if gaps are available between the solar module rows as the pair of rails connected to upper edge and lower edge of the solar module row cannot provide the required movement to the movable frame in condition of a misaligned solar module row.

Also, U.S. Pat. No. 9,455,665 B1 discloses a solar tracker waterless cleaning system for cleaning solar modules that includes a waterless cleaning apparatus operable to clean a surface of solar modules, a supporting frame for supporting movement of the waterless cleaning apparatus, and a controller coupled to the cleaning apparatus and to the support frame to move the cleaning apparatus in the length direction and the width direction of the solar module row being cleaned. The solar tracker waterless cleaning system further includes two rails positioned horizontally parallel to a solar module row, a plurality of rail segments, and a plurality of rail switching points which increases number of components and weight of the system, and thus, increases installation cost of the system. Further, the solar tracker waterless cleaning system cannot be used with a solar module that includes a plurality of solar module rows that are misaligned to each other as the two rails positioned horizontally parallel to a solar module row cannot provide the required movement to the waterless cleaning apparatus in condition of a misaligned solar module row.

However, while existing cleaning devices of solar modules can be effective at cleaning mirrors, it is resource intensive, both in terms of man-hours and water consumption, and therefore is performed periodically, such as once every two weeks. In between such cleanings, surfaces can again become undesirably contaminated. Further, the existing cleaning devices of solar modules are costly, labor intensive and consume high volumes of water. Due to shortage of water in arid and desert areas, solar module cleaning using water, or wet cleaning, is a major obstacle for the solar industry.

Thus, it can be seen from the above review of the prior art that it remains a need for a cleaning system for cleaning rows of various dimensions of aligned solar modules, that removes dust by sweeping, which lowers cost, and faster than most cleaning robots available to date on the market, which requires no additional superstructure like guiding rails, and which can account for light misalignments of the rows.

While there is certainly nothing wrong with the conventional solar module cleaning systems, there still exists a need to provide an improved, portable, flexible, cost effective, power consumption effective, waterless solar module cleaning system and method for cleaning dust and other foreign matter accumulated on solar modules that can be used with solar modules even if one or more solar modules are misaligned. Further, there is a need in the art of system and method for cleaning dust and other foreign matter accumulated on solar modules that can be used with solar module rows and blocks having one or more misaligned solar modules, without requiring any external rails and customizable as per the requirements of the solar modules or users. Furthermore, there is also a need in the art to provide an improved, portable, flexible, cost effective, power consumption effective, robotic docking train system that enables the waterless solar module cleaning system for cleaning dust and other foreign matter accumulated on solar modules to be docked and moved from one row to another row without any manual intervention.

Solar modules performance may decline during operation due to reasons such as microcrack damages not visible to eye, diode failures, cell interconnect breakage, junction box failures. These can be identified using instruments such as thermographic cameras, IR sensors and EL scanners. These instruments are used manually for inspection in current art. There is a need in prior art to automate inspection process. All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about”. Accordingly, in some embodiments, the numerical value set forth in the written description and attached claims are approximations that can vary depending upon the desired properties sought to be obtained by a particular embodiment. In some embodiments, the numerical value should be construed in light of the number of reported significant digits and by applying ordinary rounding techniques. Notwithstanding that the numerical ranges and value setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

It is an object of the present disclosure to provide system and method for cleaning dust and other foreign matter accumulated on solar modules.

Another object of the present disclosure is to provide system and method for cleaning dust and other foreign matter accumulated on solar modules that do not require water or any other liquid/gel as a cleaning medium.

Another object of the present disclosure is to provide system and method for cleaning dust and other foreign matter accumulated on solar modules that can be used with solar module rows and blocks having one or more misaligned solar modules.

Another object of the present disclosure is to provide system and method for cleaning dust and other foreign matter accumulated on solar modules that do not require any support rails.

Another object of the present disclosure is to provide system and method for cleaning dust and other foreign matter accumulated on solar modules that can clean a large area in one cleaning cycle.

Another object of the present disclosure is to provide system and method for cleaning dust and other foreign matter accumulated on solar modules that are light weight.

Another object of the present disclosure is to provide system and method for cleaning dust and other foreign matter accumulated on solar modules that are portable and customizable.

Another object of the present disclosure is to provide system and method for cleaning dust and other foreign matter accumulated on solar modules using feather or man-made non-abrasive brushes.

Another object of the present disclosure is to provide system and method for docking and moving an automated dust removing system from one row to another row using automated system and method

Another object of the present disclosure is to provide a robotic docking train system that enables the system and method for cleaning dust and other foreign matter accumulated on solar modules to be docked and moved from one row to another row without any manual intervention.

Another object of the present disclosure is to provide a robotic solar duster and inspection system that enables the system and method for inspecting the solar modules in automated method for damages using cameras or sensors mounted on the system.

These and other objects of the present invention will become readily apparent from the following detailed description taken in conjunction with the accompanying drawings.

### SUMMARY OF THE INVENTION

This summary is provided to introduce a selection of concepts in a simplified form to be further described below in the Detailed Description. This summary is not intended to identity key features or essential features of the claimed subject matter, nor is it intended to be used to limit the scope of the claimed subject matter.

The present disclosure relates to a robot system for cleaning and inspecting solar modules, and the like, among services robots or field robots. In particular, the present disclosure relates to a robotic cleaning system for cleaning power generating elements called as solar modules for photovoltaic power generation, and the like.

The technical problem to be solved by the present invention is to provide a robotic waterless photovoltaic solar module cleaning mechanism for economically cleaning, with high workability, plate-shaped members, such as solar modules used in photovoltaic power generation.

Another technical problem to be solved by the present invention is to provide a robotic solar module inspection mechanism for economically checking solar modules for damages.

The present invention has been made to solve the above-described problems, and has an object to provide a waterless photovoltaic solar module robotic cleaning and inspection system and a method of controlling the same for economically cleaning, with high workability, plate-shaped members, such as solar modules used in photovoltaic power generation. The waterless solar module robotic cleaning system and method according to the present disclosure is portable, flexible, cost effective, power consumption effective. Further, the waterless solar module robotic cleaning and inspection system and method enables to clean dust and other foreign matter accumulated on solar modules that can be used with solar module rows and blocks having one or more misaligned solar modules, without requiring any external rails and customizable as per the requirements of the solar modules or users.

An aspect of the present disclosure relates to a robotic cleaning system for waterless cleaning modules for photovoltaic power generation. The robotic cleaning system includes a main frame having at least two parallel components and a trolley mounted between said two parallel components on the main frame. The main frame can include a plurality of wheels such that the plurality of wheels moves forward and/or backward laterally on surface of the panels or the reflecting mirrors. The trolley can include one or more waterless cleaning tools adapted to roll on a horizontal axis of said main frame to ensure waterless cleaning of surface of the panels or the reflecting mirrors.

In an aspect, main frame is rectangular or square or triangular in shape.

In an aspect, said waterless cleaning tool is any or combination of a duster, preferably a feather duster, a brush made of nylon or man-made material, preferably with bristles, wire or other filaments, and a wiper.

In an aspect, the main frame can further include one or more supporting members adapted to be connected with said surface on at least one side of the solar modules to ensure proper alignment of dusters/brushes with the surface of the modules. In another aspect, said supporting members are adapted to be in contact even when the modules are not properly aligned to each other or having gaps between the modules.

In an aspect, the main frame can further include a roller adapted to guide said plurality of wheels and thereby provide longitudinal movement of the trolley.

In an aspect, the main frame is adapted to roll on the horizontal axis using a wire rope mechanism, wherein said wire rope mechanism comprises at least one rope connected to the main frame at one end and to the trolley at the other end.

In an aspect, said rope is pre-configured operationally such that rotation of the roller in a first direction allows upward movement of the trolley, and rotation of the roller in a second direction allows downward movement of the trolley.

In an aspect, said main frame can include one or more electrical components adapted to provide power for motion of the main frame and/or the trolley. In another aspect, the one or more electrical components are any or combination of rechargeable batteries, electronic motion controllers, sensors, and solar cells to charge rechargeable batteries.

In an aspect, said plurality of wheels can include at least three smaller wheels that enable to achieve climbing movement of robotic cleaning system over misaligned panels and/or gaps in the panels.

In an aspect, a lateral width of the trolley is larger than a lateral width of the main frame.

In an aspect, the movement of the plurality of wheels and/or said rolling of the trolley is based at least on information received from one or more sensors. In another aspect, said sensors are adapted to provide information associated with start and end of said panels to initiate and/or stop cleaning.

In an aspect, said robotic cleaning system can include one or more indicators adapted to provide information associated with the cleaning of the panels for photovoltaic power generation or reflecting mirrors for solar thermal power generation.

In an aspect, said robotic cleaning system is adapted to move along pre-configured/pre-existing rails of the panels.

In an aspect, said robotic cleaning system is adapted to be moved using any or combination of manually or using fixed docking station or using robotic docking train automated system.

In an aspect, the waterless cleaning tool can be, without any limitation, a vertical brush or an inclined brush.

In an aspect, the robotic cleaning system includes a mounting apparatus to inspect one or more pre-defined operations associated with said robotic cleaning system. In an example, the mounting apparatus is, preferably, a camera.

An aspect of the present disclosure relates to a system for waterless cleaning of modules for photovoltaic power generation. The system can include a robotic cleaning system as recited above and a robotic docking train system, operatively and communicably coupled with the robotic cleaning system, adapted to control at least one of docking, undocking, forward and backward movement of the robotic cleaning system and carry the robotic cleaning system from one row of panels to another row.

In an aspect, said robotic cleaning system is adapted to move along pre-configured/pre-existing edges or rails of the panels.

In an aspect, said robotic docking train system is operated using solar energy and includes one or more sensors and/or controllers to communicate with at least the controller of said robotic cleaning system.

In an aspect, the solar duster can have cleaning brushes vertical or inclined attached to main frame for cleaning purposes.

In an aspect, for inspecting the modules, instruments such as thermographic cameras, IR sensors can be mounted on top.

An aspect of the present disclosure relates to a method for waterless cleaning of modules for photovoltaic power generation. The method can include the steps of initializing, by a robotic docking train system, a robotic cleaning system when start of a row associated with the panels is detected by a plurality of sensors; determining, by the robotic cleaning system, a direction in which the robotic cleaning system is supposed to move, and accordingly initiating a movement of a trolley having one or more waterless cleaning tool provided on the robotic cleaning system in longitudinal direction on surface of said panels for waterless cleaning of the surface; determining, by a plurality of sensors, an end of the row associated with the panels; moving, upon determining end of the row, by the robotic docking train system, the robotic cleaning system to at least one next row using rails; and repeating the steps initializing, determining the direction, determining end of the row, and moving, till an end of rows is detected by the plurality of sensors.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates a system having a proposed robotic cleaning system and a proposed robotic docking train system, in accordance with an implementation of the present disclosure.

FIG. 2A illustrates an exemplary top view of the proposed robotic cleaning system, in accordance with an implementation of the present disclosure.

FIG. 2B illustrates an exemplary side view of the proposed robotic cleaning system, in accordance with an implementation of the present disclosure.

FIG. 2C illustrates an exemplary front view of the proposed robotic cleaning system, in accordance with an implementation of the present disclosure.

FIG. 2D illustrates an exemplary isometric representation of the proposed robotic cleaning system, in accordance with an implementation of the present disclosure.

FIG. 3A illustrates an exemplary top view of robotic docking train system, in accordance with an implementation of the present disclosure.

FIG. 3B illustrates an exemplary side view of robotic docking train system, in accordance with an implementation of the present disclosure.

FIG. 3C illustrates an exemplary front view of robotic docking train system, in accordance with an implementation of the present disclosure.

FIG. 3D illustrates an exemplary isometric representation of robotic docking train system, in accordance with an implementation of the present disclosure.

FIG. 4 illustrates an exemplary flowchart illustrating working of the integrated system containing robotic docking train system and robotic cleaning system, in accordance with an implementation of the present disclosure.

FIG. 5 illustrates an exemplary flowchart illustrating working of the proposed robotic cleaning system, in accordance with an implementation of the present disclosure.

FIG. 6A illustrates an exemplary isometric view of the proposed robotic cleaning system with vertical brush, in accordance with an implementation of the present disclosure.

FIG. 6B illustrates an exemplary top view of the proposed robotic cleaning system with vertical brush, in accordance with an implementation of the present disclosure.

FIG. 6C-6D illustrates an exemplary mechanism for lifting of vertical brush, in accordance with an implementation of the present disclosure.

FIG. 7A illustrates an exemplary isometric view of the proposed robotic inspection system, in accordance with an implementation of the present disclosure.

FIG. 7B illustrates an exemplary top representation of the proposed robotic inspection system, in accordance with an implementation of the present disclosure.

### DETAILED DESCRIPTION OF THE INVENTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Unless the context requires otherwise, throughout the specification which follow, the word “comprise” and variations thereof, such as, “includes” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

Various terms as used herein. To the extent a term used in a claim is not defined, it should be given the broadest definition persons in the pertinent art have given that term as reflected in printed publications and issued patents at the time of filing.

Reference will now be made in detail to the exemplary embodiments of the present disclosure, examples of which are illustrated in the accompanying drawings. Wherever possible, the same reference numbers are used in the drawings and the description to refer to the same or like parts.

The following discussion provides many example embodiments of the inventive subject matter. Although each embodiment represents a single combination of inventive elements, the inventive subject matter is considered to include all possible combinations of the disclosed elements. Thus if one embodiment includes elements A, B, and C, and a second embodiment includes elements B and D, then the inventive subject matter is also considered to include other remaining combinations of A, B, C, or D, even if not explicitly disclosed.

Embodiments of the present disclosure relates to a robot system for cleaning a glass surface, solar panels (also interchangeably referred to as “photovoltaic solar panels” or “solar modules”), and the like, among services robots or field robots. In particular, the present disclosure relates to a robotic cleaning system for cleaning power generating elements called as solar modules or panels for photovoltaic power generation, and the like.

In an embodiment, the system according to the present disclosure includes a robotic cleaning system for waterless cleaning of modules for photovoltaic power generation, and a robotic docking train system for moving said robotic cleaning system from one row to the another row when the cleaning of the row is completed.

In an exemplary embodiment, said robotic docking train system and said robotic cleaning system includes one or more sensors configured to determine start and/or end of row associated with the modules. Further, said robotic docking train system and said robotic cleaning system includes one or more controllers to intercommunicate with each other and perform operations such as but not limited to cleaning, moving forward and/or backward, and moving to next and/or previous row and the like.

In an exemplary embodiment, at the start of the process said robotic cleaning system can be docked with said robotic docking train system. In this scenario, the robotic docking train system determines a start of the row of modules using one or more sensors and accordingly triggers the controller of the robotic cleaning system to initiate the process of waterless cleaning. Based on the trigger, the robotic cleaning system is configured to determine a direction in which it should travel and clean the surface using the sensors, and accordingly initiating a movement of a trolley having one or more waterless cleaning tool provided on the robotic cleaning system in longitudinal direction on surface of said modules for waterless cleaning of the surface.

In an exemplary embodiment, when an end of the row of modules is sensed by the one or more sensors, a trigger is sent to the controller of the robotic cleaning system and accordingly the direction of the robotic cleaning system is reversed. In this scenario, when the robotic cleaning system reaches in close proximity of the robotic docking train system, the sensors of the robotic docking train system enables the robotic docking train system to be docked with the robotic cleaning system. Upon docking, the robotic cleaning system is moved to next row of the modules using the robotic docking train system and is aligned to initiate the process of cleaning. In an exemplary embodiment, the process of cleaning is repeated till the end of rail associated with the plurality of modules is detected by the sensors of the robotic docking train system.

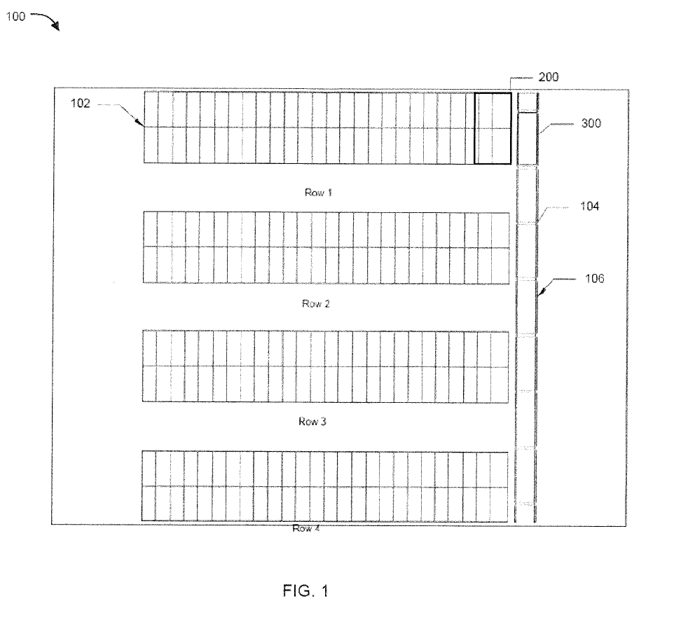

FIG. 1 illustrates a system 100 having a proposed robotic cleaning system 200 (also interchangeably referred to as “waterless solar module cleaning system”) and a proposed robotic docking train system 300, in accordance with an implementation of the present disclosure. For didactic purpose, as shown in FIG. 1 a system 100 can be used for waterless cleaning of modules for photovoltaic power generation. The system 100 can include a plurality of rows (not numbered) of solar modules 102 each having start and end point.

In an exemplary embodiment, system 100 can include a robotic cleaning system 200 and a robotic docking train system 300. The robotic cleaning system 200 is configured to perform waterless cleaning of modules 102 for photovoltaic power generation. The robotic docking train system 300 can be configured to control at least one of docking, undocking, forward and backward movement of the robotic cleaning system 200 and carry the robotic cleaning system 200 from one row of modules 102 to another row.

In an exemplary embodiment, the robotic cleaning system 200 can operate automatically using solar power and can be independent of any docking systems.

In an exemplary embodiment, the system 100 can include a plurality of Y-structure supports 104 and C-channels 106 (also referred to as rails) on which said robotic docking train system 300 moves and also enables the robotic docking train system 300 to carry the robotic cleaning system 200 form one row to another row. In an exemplary embodiment, the Y-structure supports 104 can provide a locking mechanism to automatically lock the robotic docking train system 300 in alignment with the row.

In an exemplary embodiment, robotic cleaning system 200 and robotic docking train system 300 can work together and move from one row to another row on rails. In an exemplary embodiment, the waterless solar module cleaning system 200 and robotic docking train 300 can include controllers that can process information received from a remote control, plurality of sensors and other electronic devices and provide appropriate commands to control docking and undocking movement of robotic cleaning system 200 and upwards and downward movement of robotic docking train system 300.

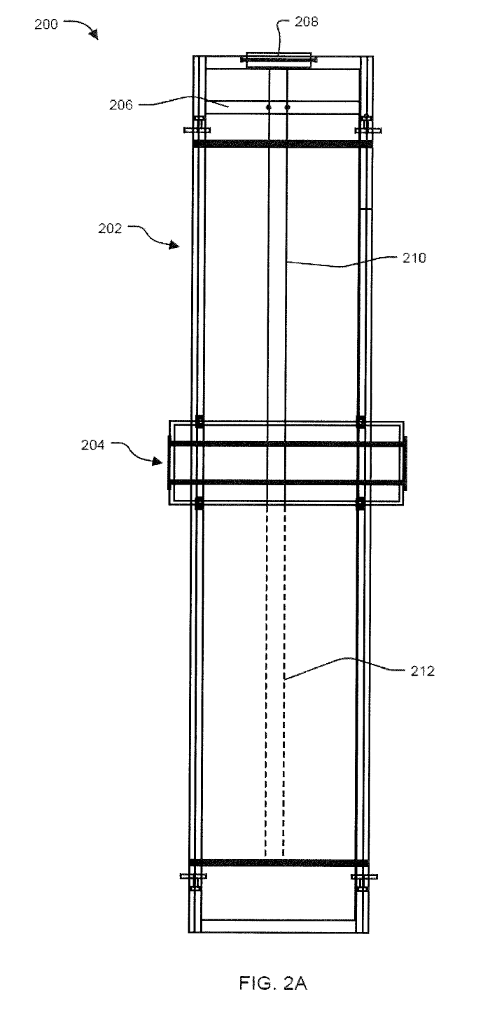

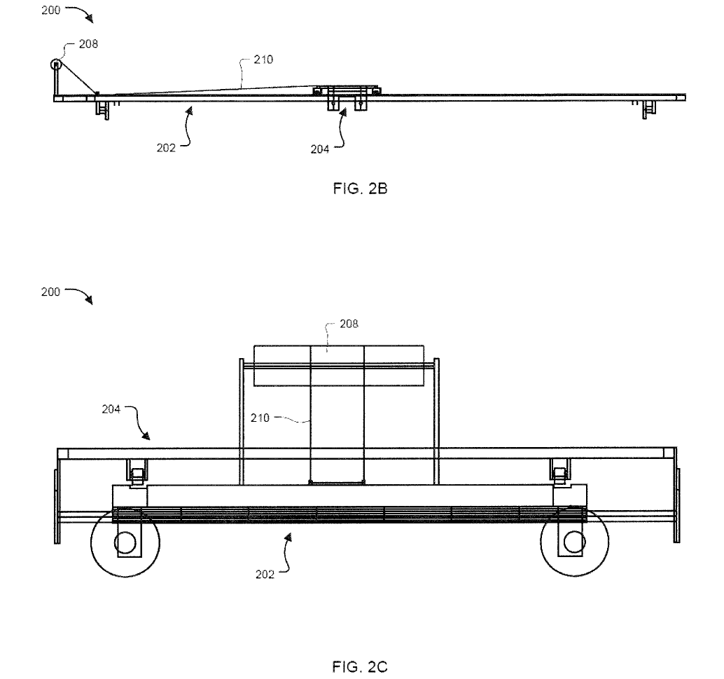

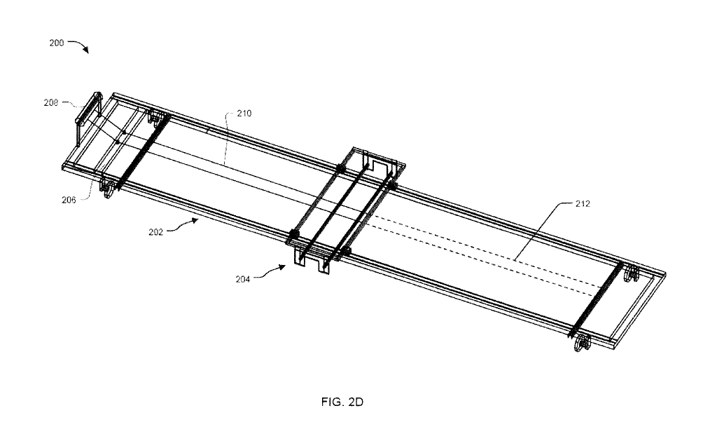

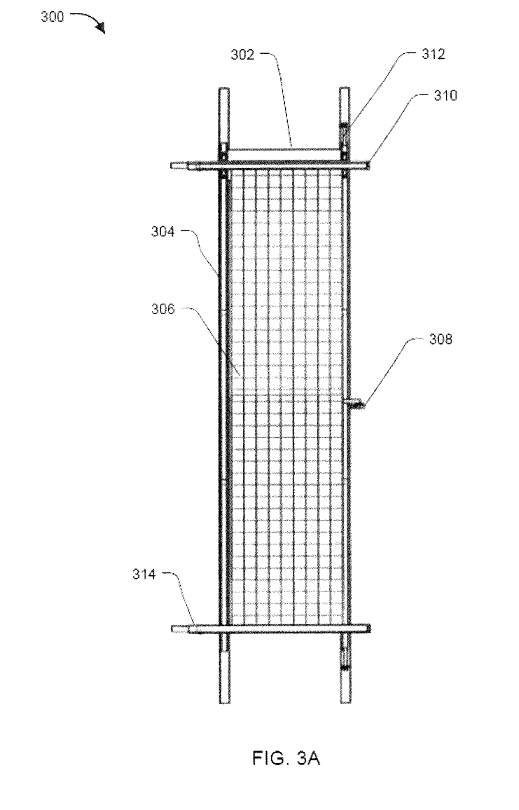

FIGS. 2A-2D illustrates exemplary representations of the proposed robotic cleaning system 200 (also interchangeably referred to hereafter as “waterless solar module cleaning system”) in accordance with an implementation of the present disclosure. In an aspect, the waterless solar module cleaning system 200 can include a main frame 202 and a trolley 204 mounted on the main frame 202. The main frame 202 can be rectangular in shape and can be installed with a plurality of wheels such that the plurality of wheels can move laterally on surface of the solar module system. The trolley 204 can include one or more dusters/brushes/wipers that can roll on a horizontal axis to ensure cleaning of surface of the solar module accumulated with dust and other foreign matter.

FIG. 2A illustrates top view of the waterless solar module cleaning system 200, FIG. 2B illustrates side view of the waterless solar module cleaning system 200, FIG. 2C illustrates front view of the waterless solar module cleaning system 200, and FIG. 2D illustrates isometric view of the waterless solar module cleaning system 200.

In an aspect, solar modules are arranged in the form of a solar array comprising a plurality of solar modules arranged in series or parallel depending upon requirement of electrical energy. The solar module system comprising the plurality of solar modules can either be available in a position parallel to a horizontal axis, or it can be aligned to a certain angle so as to increase the intensity of incoming solar radiation on the solar modules. The robotic cleaning system 200 can be installed on the solar module system in both of its positions.

In an aspect, the main frame 202 can include a supporting member 206 that can remain in contact with surface of the solar modules to ensure proper alignment of dusters/brushes with the surface of the solar modules to be cleaned even when the solar modules are not properly aligned to each other, or gaps are available between the solar modules. The main frame 202 can further include a roller 208 that can enable longitudinal movement of the trolley 204.

In another aspect, a wire rope mechanism 210, 212 can be configured with the roller 208 at one end and the trolley 204 at the other end such that rotation of the roller 208 in a direction can allow upward movement of the trolley 204, and rotation of the roller 208 in an opposite direction can allow downward movement of the trolley 204.

In another aspect, the main frame 202 can carry various electrical equipments including, but not limited to, rechargeable batteries, electronic motion controller, sensors, and solar cells to charge batteries that power the robotic cleaning system 200.

In an aspect, the main frame 202 can be installed with a plurality of wheels that can allow lateral movement of the main frame 202 on the surface of the solar modules, and the trolley 204 can be mounted on the main frame 202 and it can be movable in a longitudinal direction with the help of a plurality of wheels that can roll on surface of the main frame 202.

In an aspect, the main frame 202 can be installed with guiding wheels made up of 3 or smaller wheels that enable climbing movement of system 200 over misaligned solar modules and gaps.

In an aspect, the cleaning system 200 can clean surface of the solar modules without using water as a cleaning medium. Dust and other foreign matter are removed for the solar module system when the dusters configured with the trolley 204 wipe the surface of the solar modules.

In an aspect, dust and other foreign matter are removed when the trolley moves in longitudinal direction in a cleaning cycle, and when the main frame moves in the lateral direction, cleaning operation is halted such that cleaning cycle of a new row of the solar module system can be initiated.

In an aspect, lateral width of the trolley 204 is larger than lateral width of the main frame 202 that can allow cleaning of a larger area in one pass of the trolley and thus, makes the cleaning operation more efficient than cleaning devices known in the art. Further, as a larger solar module area is cleaned in one cycle, less time is taken by the cleaning system 200 to complete cleaning of an entire solar module system. Hence, effectiveness of the cleaning system is improved by using the robotic cleaning system 200.

In an aspect, the supporting member 206 of the main frame 202 allows the main frame 202 to remain in contact with surface of the solar modules to ensure proper alignment of dusters/brushes with the surface of the solar modules to be cleaned even when the solar modules are not properly aligned to each other, or gaps are available between the solar modules. Therefore, no additional rails are required to effect lateral movement of the main frame along the surface of the solar module system. Thus, less number of components is required to effectuate cleaning operation of the solar module system and weight of the cleaning system 200 is further reduced due to lesser number of components.

In an aspect, the waterless solar module robotic cleaning system 200 can include a controller that can process information received from a plurality of sensors and other electronic devices and provide appropriate commands to control longitudinal movement of the trolley 204 and lateral movement of the main frame 202. In an aspect, the controller can also control motion of the dusters so as to provide efficient cleaning operation in various environmental scenarios. Further, the controller can be programmed to allow automatic movement of the trolley 204 in longitudinal direction and the main frame 202 in lateral direction. In addition, the controller can be configured to provide a user an alert when a cleaning cycle is complete so that the user can manually initiate cleaning operation of a next solar module row. In an aspect, the alert generated by the controller can be in the form of an audio/visual alarm, or a tactile alarm.

In an aspect, a plurality of sensors can be installed either on the surface of the solar modules or at lateral sides of the solar modules. The plurality of sensors can sense gaps between solar modules and provide appropriate information to the controller to continue the cleaning process till end of row is reached and cleaning cycle is complete.

In an aspect, a left sensor and a right sensor can be installed on lateral sides of the solar module system to allow lateral movement of the main frame 202 and sense the presence of gaps or misalignment between solar modules. The left and right sensors are also configured to detect start and end of row of the solar module system. In an aspect, a top sensor and a bottom sensor can be installed on longitudinal sides of the solar module system to allow longitudinal movement of the trolley 204 and sense the presence of gaps or misalignment between solar modules. The top and bottom sensors are also configured to sense top and bottom of each row of the solar module.

In an aspect, the dusters can be made of natural feathers and/or manmade materials that do not create any abrasion on surface of the solar module. The dusters can be self-adjustable and self-aligned with the surface of the solar modules, and a provision of manual alignment is provide to allow a user to manually adjust and align the dusters to the surface of the solar modules to provide an efficient cleaning operation.

In an aspect, the robotic cleaning system 200 is portable for a solar power plant having large number of solar module rows and the cleaning system includes a provision which can allow the robotic cleaning system 200 to be moved to other row of modules manually or using fixed docking station or using robotic docking train automated system 300 (also interchangeably referred to as “robotic docking train system 300”).

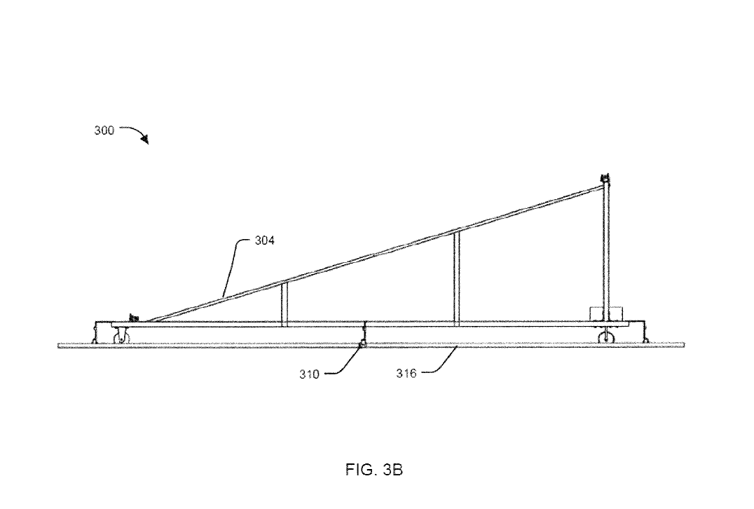

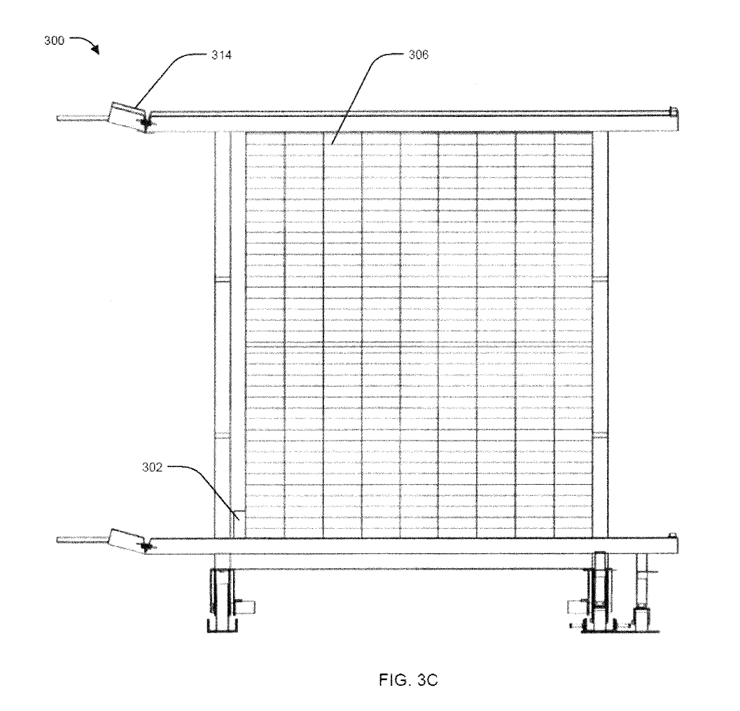

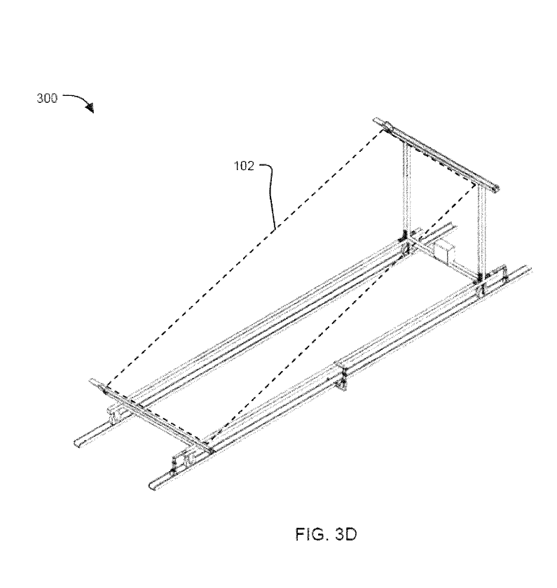

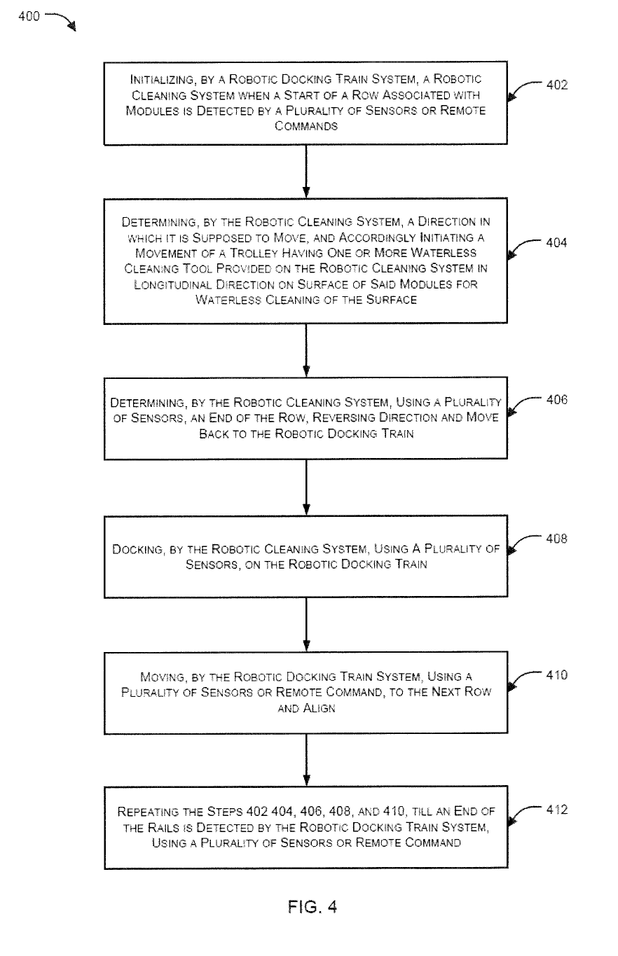

FIG. 3A-3D illustrates exemplary representations of a proposed robotic docking train system 300 that carries waterless solar module robotic cleaning system 200 from one row to another in accordance with an implementation of the present disclosure.

In an aspect, the robotic docking train system 300 can include a controller 302, a frame 304 and one or more solar modules 306 mounted on the frame 304 for charging batteries (not shown) associated with the robotic docking train system 300, at least one row position sensor 308, at least one cleaning robot parked sensor 310, at least one end of row detector sensor 312, and a bridge 314 to couple with at least one row of the solar module 102.

In an aspect, the frame 302 can be rectangular/triangular box in shape and can be installed with a plurality of wheels such that the plurality of wheels can move forward or backward on rails. The system can include one or more solar modules 304 and batteries to charge batteries for robotic docking train system 300 and/or robotic cleaning systems 200.

In an aspect, the robotic docking train system 300 can include end of rail detection sensors 310 on both sides of the frame 304.

In an aspect, the robotic docking train system 300 can include a row position sensor 306 to identify the row as it moves from one row to another row. It also has sensor, cleaning robot parked sensor 308, to identify if robotic cleaning system 200 is on the docking train 300 or away.

In as aspect, the robotic docking train system has the controller 302 that is configured to move one or more wheels (not numbered) associated with the robotic docking train 300 to move from one row to another row, senses row position, battery charge levels. In an aspect, the controller 302 of the robotic docking train 300 communicates in wired mode or wireless mode with robotic cleaning system 200 and/or a central controller of the robotic cleaning system 200.

FIG. 3A illustrates a top view of the robotic docking train system 300, which depicts a controller 302, a frame 304 and one or more solar modules 306 mounted on the frame 304 for charging batteries (not shown) associated with the robotic docking train system 300, at least one row position sensor 308, at least one cleaning robot parked sensor 310, at least one end of row detector sensor 312, and a bridge 314 to couple with at least one row of the solar module 102.

FIG. 3B illustrates side view of the robotic docking train system 300, which depicts solar modules 306 mounted on the frame 304 for charging batteries (not shown) associated with the robotic docking train system 300, at least one row position sensor 308, and one or more rails 316 to move the robotic docking train system 300.

FIG. 3C illustrates front view of the robotic docking train system 300, which depicts a controller 302, solar modules 306 mounted on the frame 304 for charging batteries (not shown) associated with the robotic docking train system 300, and a bridge 314 to couple with at least one row of the solar module 102.

FIG. 3D illustrates isometric view of the robotic docking train system 300 with the solar panel 102.

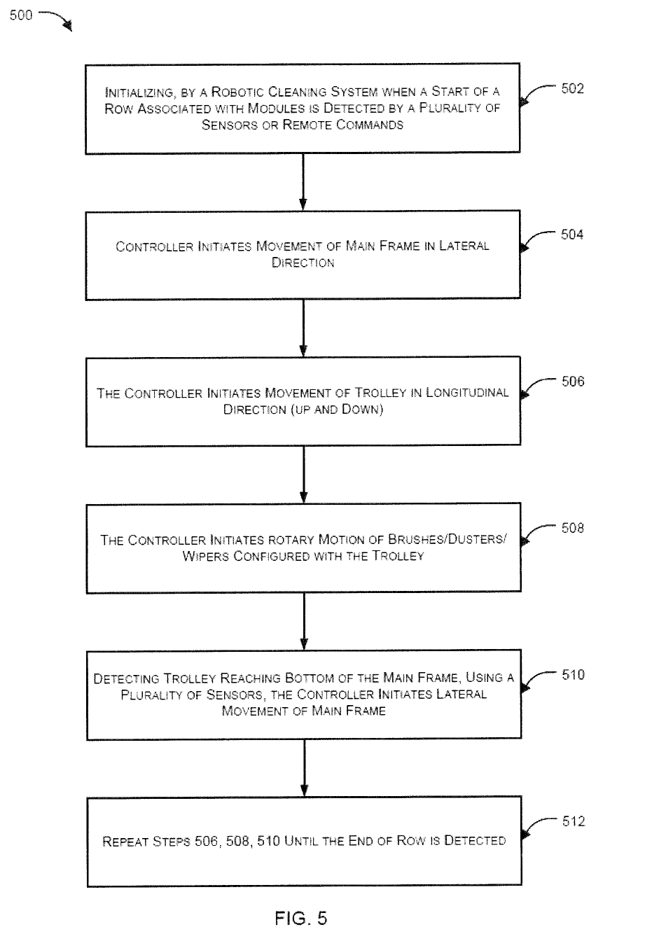

FIG. 4 illustrates an exemplary flowchart illustrating working of the overall system, in accordance with an implementation of the present disclosure. In an embodiment, the process of cleaning of solar module system can include the steps of initializing the waterless solar module robotic cleaning system 200 when start of a row is detected by the plurality of sensors, determining the direction in which the main frame 202 is supposed to move, and initiating movement of the trolley 204 in longitudinal direction on either inclined or flat solar module system.

In an exemplary embodiment, the process of cleaning of the solar module system 100 using the waterless solar module robotic cleaning system 200 can include the step of initiating rotation of dusters provided on the trolley 204, and once a cleaning cycle is complete, allow movement of the main frame 202 to next row of the solar module system 100.

In an exemplary embodiment, the process of cleaning of solar module system can include the steps of alerting a user with an alarm when a cleaning cycle is complete so that the user can manually install the waterless solar module cleaning system 200 to a next row to be cleaned. The robotic cleaning system 200 is designed to restart from any position.

In an exemplary embodiment, the method of waterless solar module cleaning system 200 of surface of solar modules 102 accumulated with dust and other foreign matter can include the steps of initiating movement of the main frame 202 in lateral direction and movement of the trolley 204 in longitudinal direction. Further, the sensors can provide the controller with information regarding required movement of the main frame 202 and the trolley 204, and the controller can control movement of the main frame 202 and the trolley 204.

Accordingly, FIG. 4 illustrates a flowchart 400 for waterless cleaning of modules for photovoltaic power generation.

At step 402, a robotic cleaning system 200 is initialized by a robotic docking train system 300, when start of a row associated with the modules is detected by a plurality of sensors or remote commands.

At step 404, a direction in which the robotic cleaning system 200 is supposed to move is determined by the robotic cleaning system 200, and accordingly a movement of a trolley 104 having one or more waterless cleaning tool provided on the robotic cleaning system 200 is initiated in longitudinal direction on surface of said modules for waterless cleaning of the surface

At step 406, an end of the row associated with the modules is determined by the robotic cleaning system 200 using a plurality of sensors and thereby reversing direction of the robotic cleaning system 200 to move back to the robotic docking train.

At step 408, the robotic cleaning system 200 is docked on the robotic docking train system 300.

At step 410, the robotic cleaning system 200 is moved to the next row of the solar panel and aligned with the row using the robotic docking train system 300.

At step 412, the steps of 402, 404, 406, 408 and 410 are repeated till an end of the rails is detected by the robotic docking train system using a plurality of sensors or remote command.

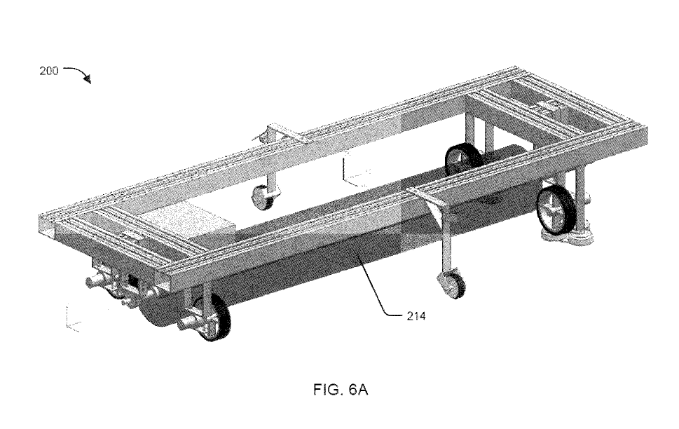

FIG. 5 illustrates an exemplary flowchart 500 illustrating working of the proposed robotic cleaning system 200, in accordance with an implementation of the present disclosure. In an aspect, as illustrated in FIG. 5, at step 502, the waterless cleaning device 200 is started when start of a row of solar modules is detected by the plurality of sensors, and at step 504, the left and right sensors can provide the controller with information about the required position of the main frame 202 and further provide the controller with information regarding presence of gaps between the solar modules. Thereafter, once a position of the main frame 202 is defined, the controller takes input from the top and bottom sensors that sense the required displacement of the trolley 204 in longitudinal direction, and at step 506, the controller initiates movement of trolley in longitudinal direction (up and down). Thereafter, at step 508, the controller detects trolley reaching bottom of the main frame, using a plurality of sensors, and accordingly the controller initiates lateral movement of main frame. Thereafter, at step 510, the steps of 502, 504, 506, and 508 are repeated till an end of the rails is detected by the robotic docking train system using a plurality of sensors or remote command. In an aspect, the cleaning system 200 can move automatically to a next adjacent set of the solar modules without manual intervention, wherein the controller can initiate movement of the main frame 202 in a required lateral direction automatically when a single column cleaning cycle is complete.

In an aspect, when cleaning cycle of a row is complete, at step 510, the controller triggers an alarm such that a user can manually lift the cleaning system 200 and place it on top of the next row of the solar module system to be cleaned. The alarm triggered by the controller can be an audio/visual alarm or a tactile alarm.

In an aspect, when cleaning cycle of a row is complete, at step 510, the controller brings the cleaning system 200 to the robotic docking train system 300 and docks it in place. The robotic docking train system 300 then moves to the next row on rails. Cleaning system 200 then undocks from start point move on top of the next row of the solar module system to be cleaned. All the activities of the systems can be coordinated by controllers.

In an aspect, after completion of a cleaning cycle, and initiation of a new cleaning cycle, the cleaning system 200 can continue the cleaning process until the entire solar module system has been cleaned. In addition, the cleaning system 200 can restart from any position. For instance, the cleaning system 200 can restart the cleaning process even in condition when in the presence of misalignment or gaps between the solar modules.

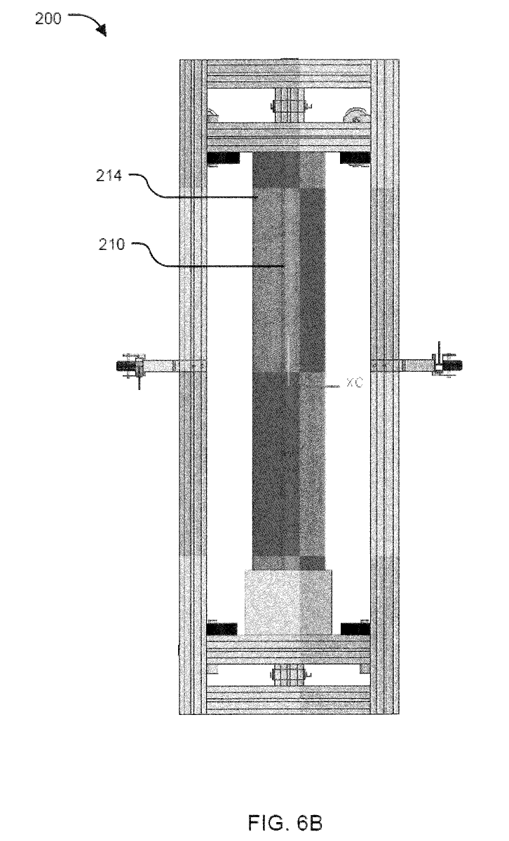

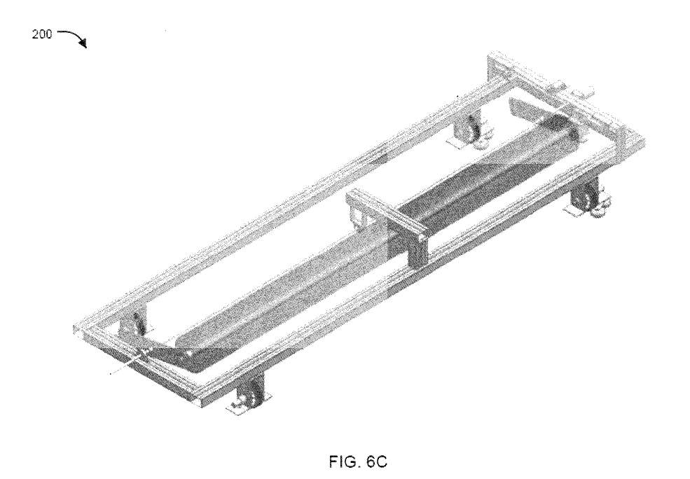

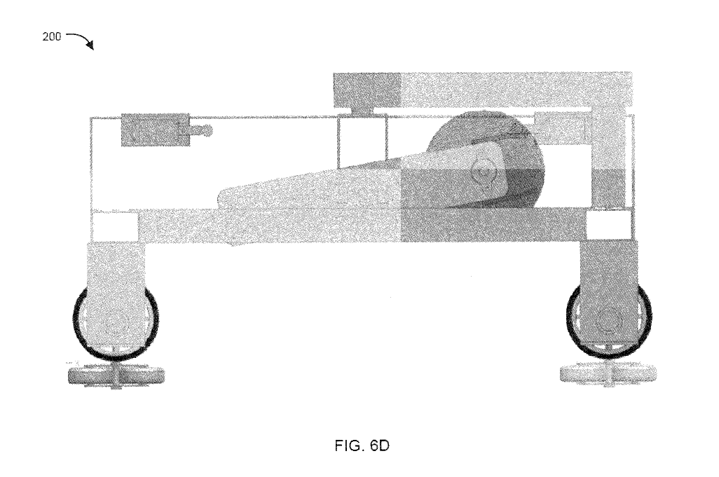

FIG. 6A and FIG. 6B illustrates a robotic cleaning system 200 with vertical brush 214. It works just like system 200 with robotic docking train 300 and processes. In an aspect, the brush 214 can be at any angle to the vertical axis. In an aspect, the brush that can be lifted up to enable crossing over humps and obstacles as illustrated in FIG. 6B. FIG. 6C-6D illustrates an exemplary mechanism for lifting of vertical brush, in accordance with an implementation of the present disclosure. In an exemplary embodiment, said waterless cleaning tool 214 is moved up and down to cross over obstacles, if any, for example tracking system gears.

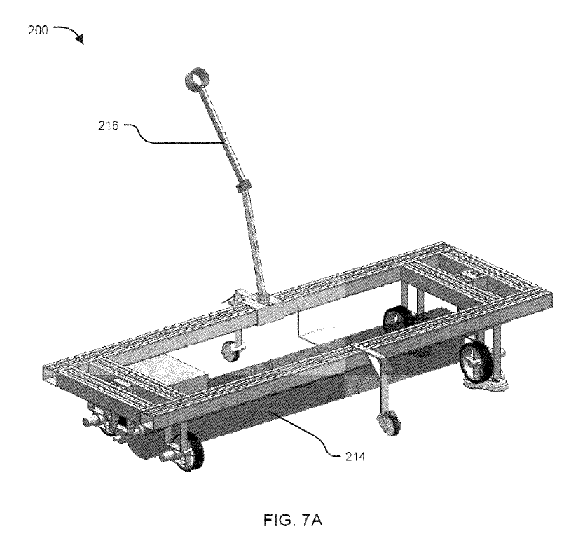

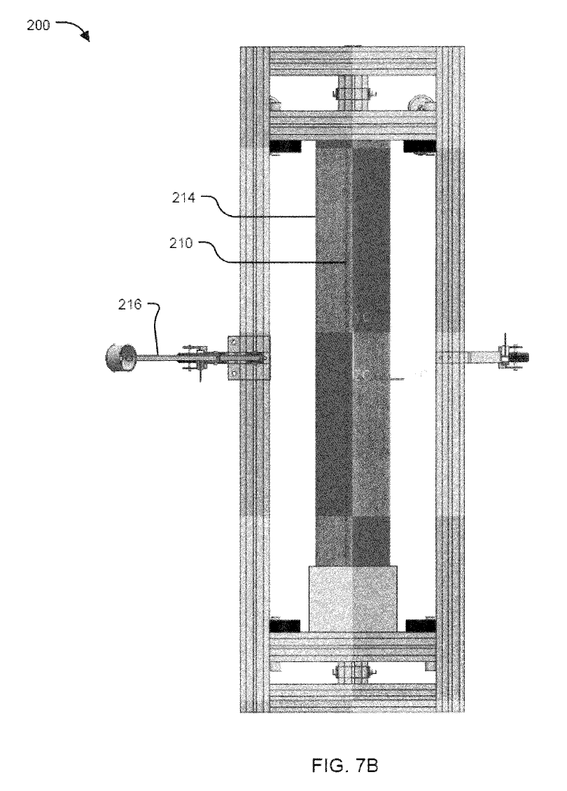

FIG. 7A and FIG. 7B illustrates a robotic cleaning system 200 with a robotic inspection system 216 with instruments mounted. It works just like system 200 with robotic docking train 300 and processes.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

The present disclosure provides system and method for cleaning dust and other foreign matter accumulated on solar modules.

The present disclosure provides system and method for cleaning dust and other foreign matter accumulated on solar modules that do not require water as a cleaning medium.

The present disclosure provides system and method for cleaning dust and other foreign matter accumulated on solar modules that can be used with solar modules having one or more misaligned solar modules in a row.

The present disclosure provides system and method for cleaning dust and other foreign matter accumulated on solar modules that do not require any support rails.

The present disclosure provides system and method for cleaning dust and other foreign matter accumulated on solar modules that are light in weight.

The present disclosure provides system and method for cleaning dust and other foreign matter accumulated on solar modules that are portable.

The present disclosure provides system and method for cleaning dust and other foreign matter accumulated on solar modules that can cross over large obstacles such as tracking system gears.

The present disclosure provides system and method for cleaning dust and other foreign matter accumulated on solar modules using autonomous systems with remote monitoring and control.

The present disclosure provides system and method for cleaning dust and other foreign matter accumulated on solar modules that can clean a large area in one cleaning cycle.

The present disclosure provides system and method for moving the cleaning/dusting system using a robotic docking train system.

The present disclosure provides a robotic docking train system that enables the system and method for cleaning dust and other foreign matter accumulated on solar modules to be docked and moved from one row to another row without any manual intervention.

The present disclosure provides a robotic solar duster system with vertical brushes and inclined brushes.

The present disclosure provides a robotic solar inspection system for automatic inspection.

1. A robotic cleaning system for waterless cleaning of modules for photovoltaic power generation, the system comprising:
a main frame having at least two parallel components and a trolley mounted between said two parallel components on the main frame, wherein:
said main frame comprises a plurality of wheels such that the plurality of wheels move forward and/or backward laterally on surface of the modules; and
said trolley comprises one or more waterless cleaning tool adapted to roll on a horizontal axis of said main frame to ensure waterless cleaning of surface of the modules.

2. The robotic cleaning system as claimed in claim 1, wherein said main frame is rectangular or square or triangular in shape.

3. The robotic cleaning system as claimed in claim 1, wherein said waterless cleaning tool is any or combination of a duster, a brush, made of nylon or manmade material, wire or other filaments, or a wiper.

4. The robotic cleaning system as claimed in claim 1, wherein the main frame further comprises one or more supporting members adapted to be connected with said surface on at least one side of the solar modules to ensure proper alignment of dusters/brushes with the surface of the of the modules or the or reflecting mirrors, wherein said supporting members are adapted to be in contact even when the modules are not properly aligned to each other or having gaps between the modules.

5. The robotic cleaning system as claimed in claim 1, wherein the main frame further comprises a roller adapted to guide said plurality of wheels and thereby provide longitudinal movement of the trolley.

6. The robotic cleaning system as claimed in claim 1, wherein said main frame is adapted to roll on the horizontal axis using a wire rope mechanism, wherein said wire rope mechanism comprises at least one rope connected to the main frame at one end and to the trolley at the other end.

7. The robotic cleaning system as claimed in claim 6, wherein said rope is pre-configured operationally such that rotation of the roller in a first direction allows upward movement of the trolley, and rotation of the roller in a second direction allows downward movement of the trolley.

8. The robotic cleaning system as claimed in claim 1, wherein said main frame comprises one or more electrical components adapted to provide power for motion of the main frame and/or the trolley, and wherein the one or more electrical components are any or combination of rechargeable batteries, electronic motion controllers, sensors, and solar cells to charge rechargeable batteries.

9. The robotic cleaning system as claimed in claim 1, wherein said plurality of wheels include at least three smaller wheels that enables to achieve climbing movement of robotic cleaning system over misaligned modules and/or gaps in the modules.

10. The robotic cleaning system as claimed in claim 1, wherein a lateral width of the trolley is larger than a lateral width of the main frame.

11. The robotic cleaning system as claimed in claim 1, wherein said movement of the plurality of wheels and/or said rolling of the trolley is based at least on information received from one or more sensors, wherein said sensors are adapted to provide information associated with start and end of said modules to initiate and/or stop cleaning.

12. The robotic cleaning system as claimed in claim 1, wherein said robotic cleaning system further comprises one or more indicators adapted to provide information associated with the cleaning of the modules for photovoltaic power generation.

13. The robotic cleaning system as claimed in claim 1, wherein said robotic cleaning system is adapted to move on or along edges of the modules or support rail.

14. The robotic cleaning system as claimed in claim 1, wherein said robotic cleaning system is adapted to be moved using any or combination of manually or using fixed docking station or using robotic docking train automated system.

15. The robotic cleaning system as claimed in claim 1, wherein said waterless cleaning tool is selected from any or combination of a vertical brush or an inclined brush.

16. The robotic cleaning system as claimed in claim 1, wherein said waterless cleaning tool is adapted to move in upward direction and/or downward direction to cross over an obstacle present.

17. The robotic cleaning system as claimed in claim 1, wherein said robotic cleaning system comprises a mounting apparatus adapted to inspect one or more pre-defined operations associated with said robotic cleaning system, wherein the mounting apparatus is a camera.

18. A robotic docking train system comprises:
a controller, a frame and one or more solar modules mounted on the frame for charging batteries associated with the robotic docking train system, at least one row position sensor, at least one cleaning robot parked sensor, at least one end of row detector sensor, and a bridge to couple with at least one row of the solar module, and wherein the robotic docking train system is operatively and communicably coupled with the robotic cleaning system, adapted to control at least one of docking, undocking, forward and backward movement of the robotic cleaning system and to carry the robotic cleaning system from one row of modules to another row.

19. The robotic docking train system as claimed in claim 17, wherein the docking train can move on rails next to start of rows

20. The robotic docking train system as claimed in claim 17, wherein the docking train can move the robotic cleaning system can be moved from one row to another once it docks in either direction, based on remote or manual commands.

21. The robotic docking train system as claimed in claim 17, wherein the docking train has moveable bridges to connect the train to solar module row so that the robotic cleaning system can move on to the row.

22. The system as claimed in claim 17, wherein said robotic docking train system is operated using solar energy and includes one or more sensors and/or controllers to communicate with at least the controller of said robotic cleaning system.

23. A method for waterless cleaning of modules for photovoltaic power generation, the method comprising the steps of:
initializing, by a robotic docking train system or a remote command, a robotic cleaning system when start of a row associated with the modules is detected by a plurality of sensors;
determining, by the robotic cleaning system, a direction in which the robotic cleaning system is supposed to move, and accordingly initiating a movement of a trolley having one or more waterless cleaning tool provided on the robotic cleaning system in longitudinal direction on surface of said modules for waterless cleaning of the surface;
determining, by a plurality of sensors, an end of the row associated with the modules;
moving, upon determining end of the row, by the robotic docking train
system, the robotic cleaning system to at least one next row using rails;
repeating the steps initializing, determining the direction, determining end of the row, and moving, till an end of rows is detected by the plurality of sensors.
